(19) United States
(12) Patent Application Publication
(10) Pub. No.: US 2013/0083450 A1
(43) Pub. Date: Apr. 4, 2013

(54) DIELECTRIC COMPOSITION AND CERAMIC ELECTRONIC COMPONENT INCLUDING THE SAME

(71) Applicants: Seok Hyun YOON, Gimpo (KR); Sun Ho YOON, Suwon (KR); Chang Hoon KIM, Yongin (KR); Sang Hoon KWON, Suwon (KR)

(72) Inventors: Seok Hyun YOON, Gimpo (KR); Sun Ho YOON, Suwon (KR); Chang Hoon KIM, Yongin (KR); Sang Hoon KWON, Suwon (KR)

(73) Assignee: SAMSUNG ELECTRO-MECHANICS CO., LTD.

(21) Appl. No.: 13/372,030

(22) Filed: Feb. 13, 2012

(30) Foreign Application Priority Data
Oct. 4, 2011 (KR) 10-2011-0100771

(51) Int. Cl. H01G 4/06; C03C 14/00; C04B 35/468; C04B 35/00

(52) U.S. Cl. 361/321.4; 501/1; 501/152; 501/154; 501/153; 501/32; 501/137

(57) ABSTRACT

There is provided a dielectric composition including: a base powder; a first accessory component including a content (x) of 0.1 to 1.0 at % of an oxide or a carbonate including transition metals, based on 100 moles of the base powder; a second accessory component including a content (y) of 0.01 to 5.0 at % of an oxide or a carbonate including a fixed valence acceptor element, based on 100 moles of the base powder; a third accessory component including an oxide or a carbonate including a donor element; and a fourth accessory component including a sintering aid.

### CROSS-REFERENCE TO RELATED APPLICATIONS

This application claims the priority of Korean Patent Application No. 10-2011-0100771 filed on Oct. 4, 2011, in the Korean Intellectual Property Office, the disclosure of which is incorporated herein by reference.

### BACKGROUND OF THE INVENTION

1. Field of the Invention

The present invention relates to a dielectric composition and a ceramic electronic component including the same.

2. Description of the Related Art

Generally, electronic components using a ceramic material, such as a capacitor, an inductor, a piezoelectric element, a varistor or a thermistor, include a ceramic element formed of a ceramic material, internal electrodes formed within the ceramic element, and external electrodes mounted on surfaces of the ceramic element to be connected to the internal electrodes.

Among the ceramic electronic components, a multilayer ceramic capacitor (MLCC) includes a plurality of laminated dielectric layers, internal electrodes disposed to face each other, having dielectric layers interposed therebetween, and external electrodes electrically connected to the internal electrodes.

Multilayer ceramic capacitors have been widely used as components in computers, PDAs, mobile phones, or the like, due to strengths such as miniaturization, high capacitance, ease of mounting, or the like.

The multilayer ceramic capacitor is a chip type capacitor mounted on the printed circuit board of several types of electronic product, such as mobile communications terminal, a notebook computer, a personal computer, personal digital assistants, and the like, serving to be charged with or to discharge electricity, and has various sizes and stacked forms according to usage and capacitance.

In addition, demand for a microminiaturized, supercapacitive multilayer ceramic capacitor has increased as a size of electronic products has been reduced. Therefore, internal electrodes and a dielectric layers need to be thin to allow for miniaturization, and a product in which a large number of dielectric substances are stacked has been produced for supercapacitance.

The multilayer ceramic capacitor is manufactured by stacking a paste layer for an internal electrode and a paste layer for a dielectric layer by a sheet method, a printing method, or the like, and simultaneously firing the paste layers.

However, when dielectric materials used for the multilayer ceramic capacitor are reduced by being fired under a reductive atmosphere, the dielectric materials have semiconductor properties. For this reason, in order to implement normal capacitance and insulation characteristics in the high-capacitance MLCC, there is a need to suppress grain growth to some extent and implement non-reduction. To this end, a fixed valence acceptor is added. However, when the fixed valence acceptor is only added, since reliability of the dielectric layers may be degraded, rare earth elements may be added together with the fixed valence acceptor in order to secure the reliability.

However, demand for rare earth elements has increased, but supply thereof is insufficient and thus, the costs thereof have tended to increase.

### SUMMARY OF THE INVENTION

An aspect of the present invention provides a new method of securing high-temperature reliability in dielectric materials used for a multilayer ceramic capacitor while suppressing grain growth and non-reduction without using rare earth elements during manufacturing thereof.

According to an aspect of the present invention, there is provided a dielectric composition including: a base powder; a first accessory component including a content (x) of 0.1 to 1.0 at % of an oxide or a carbonate including transition metals, based on 100 moles of the base powder; a second accessory component including a content (y) of 0.01 to 5.0 at % of an oxide or a carbonate including a fixed valence acceptor element based on 100 moles of the base powder; a third accessory component including an oxide or a carbonate including a donor element; and a fourth accessory component including a sintering aid, wherein at % represents a composition ratio of the number of atoms.

The donor element of the third accessory component may be Ce and the at % content (z1) of the Ce may be 0.1≦z1≦x+2y.

The donor element of the third accessory component may be Nb, and the at % content (z2) of the Nb may be 0.1≦z2≦x+0.5y.

The donor element of the third accessory component may be La, and the at % content (z3) of the La may be 0.1≦z3≦x+y.

The donor element of the third accessory component may be Sb.

The content of the fourth accessory component may be 0.1 to 8.0 mol % based on 100 moles of the base powder.

The sintering aid of the fourth accessory component may be either of an oxide or a carbonate including at least one of Si, Ba, Ca, and Al, or may be glass including Si.

The base powder may be BaTiO₃ or at least one of (Ba₁₋ₓCaₓ)(Ti_{1-y}Ca_{y})O₃, (Ba₁₋ₓCaₓ)(Ti_{1-y}Zr_{y})O₃ and Ba(Ti_{1-y}Zr_{y})O₃.

The base powder may have a mean particle size of 0.5 μm or less.

The transition metal of the first accessory component may be at least one selected from a group consisting of Mn, V, Cr, Fe, Ni, Co, Cu and Zn.

The fixed valence acceptor element of the second accessory component may be at least one of Mg and Al.

According to another aspect of the present invention, there is provided a ceramic electronic component including: a ceramic element including a plurality of dielectric layers stacked therein; an internal electrode formed in the ceramic element and including a non-metal; and an external electrode formed on an outer surface of the ceramic element and electrically connected to the internal electrode, wherein the dielectric layer includes: a base powder; a first accessory component including a content x1 of 0.1 to 1.0 at % of an oxide or a carbonate including transition metals, based on 100 moles of the base powder; a second accessory component including a content (y) of 0.01 to 5.0 at % of an oxide or a carbonate including a fixed valence acceptor element, based on 100 moles of the base powder; a third accessory component including an oxide or a carbonate including a donor element; and a fourth accessory component including a sintering aid.

A thickness of each dielectric layer may be 0.1 to 10 μm.

The internal electrode may include Ni or a Ni alloy.

The internal electrode may be alternately stacked with the dielectric layer.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing a multilayer ceramic capacitor according to an embodiment of the present invention; and

FIG. 2 is a cross-sectional view taken along the line A-A′ of FIG. 1.

### DETAILED DESCRIPTION OF THE INVENTION

Embodiments of the present invention will now be described in detail with reference to the accompanying drawings.

The embodiments of the present invention may be modified in many different forms and the scope of the invention should not be limited to the embodiments set forth herein.

Rather, these embodiments are provided so that this disclosure will be thorough and complete, and will fully convey the concept of the invention to those skilled in the art.

In the drawings, the shapes and dimensions may be exaggerated for clarity, and the same reference numerals will be used throughout to designate the same or like components.

In addition, like reference numerals denote parts performing similar functions and actions throughout the drawings.

In addition, unless explicitly described otherwise, “comprising” any components will be understood to imply the inclusion of other components but not the exclusion of any other components.

The present invention relates to a dielectric composition. An example of a ceramic electronic component according to an embodiment of the present invention may include a multilayer ceramic capacitor, an inductor, a piezoelectric element, a varistor, a chip resistor, a thermistor, or the like. A multilayer ceramic capacitor as an example of the ceramic electronic component in the following description will be described below.

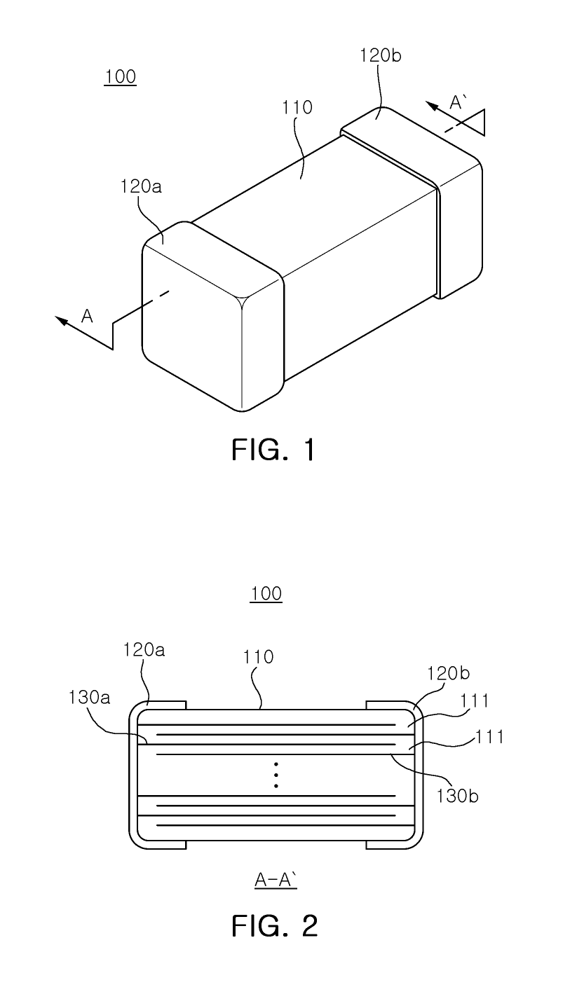

Referring to FIGS. 1 and 2, a multilayer ceramic capacitor 100 according to the embodiment of the present invention may include a dielectric layer 111 and a multilayered ceramic element 110 on which first and second internal electrodes 130a and 130b are alternately disposed. Both ends of the ceramic element 110 are provided with the first and second external electrodes 120a and 120b electrically connected with the first and second internal electrodes 130a and 130b, respectively, which are alternately disposed in the ceramic element 110.

A shape of the ceramic element 110 is not particularly limited but may preferably have a rectangular parallelepiped shape. In addition, a dimension the ceramic element 110 is not particularly limited and may be appropriately set according to a usage. For example, the dimension the ceramic element 110 may be (0.6 to 5.6 mm)×(0.3 to 5.0 mm)×(0.3 to 1.9 mm).

A thickness of the dielectric layer 111 may be arbitrarily changed so as to meet a capacitance design of a capacitor. In the embodiment of the present invention, the thickness of the dielectric layer 111 after firing may be 0.1 μm or more per one layer, more preferably, 0.1 to 10 μm. The reason is that an active layer having a too thin thickness has a small number of crystal grains present in a single layer, thereby having an adverse effect on reliability.

Each cross section of the first and second internal electrodes 130a and 130b may be stacked so as to be alternately exposed on surfaces of both opposite ends of the ceramic element 110. A capacitor circuit may be configured by forming the first and second external electrodes 120a and 120b on both ends of the ceramic element 110 and electrically connecting the first and second external electrodes 120a and 120b to the exposed cross sections of the first and second internal electrodes 130a and 130b alternately disposed.

A conductive material contained in the first and second internal electrodes 130a and 130b is not particularly limited, but may use non-metals since construction materials of the dielectric layer 111 need to have non-reduction.

An example of the conductive material may include Ni or a Ni alloy as the non-metal. An example of a Ni alloy may include at least one selected from a group consisting of Mn, Cr, Co, and Al. In this case, a content of Ni in the alloy may be 95 wt % or more.

The thickness of the first and second internal electrodes 130a and 130b may be appropriately determined according to the usage, or the like. For example, the thickness of the first and second internal electrodes 130a and 130b may preferably be 0.1 to 5 μm, more preferably, 0.1 to 2.5 μm.

The conductive material contained in the first and second external electrodes 120a and 120b is not particularly limited, but may use Ni, Cu, or a Ni alloy thereof. The thickness of the first and second external electrodes 120a and 120b may be appropriately determined according to the usage, or the like. For example, the thickness of the first and second external electrodes 120a and 120b may be, for example, about 10 to 50 μm.

The dielectric layer 111 configuring the ceramic element 110 may contain the non-reduction dielectric composition. The dielectric composition according to the embodiment of the present invention may include a base powder and the following first to fourth accessory components.

The dielectric composition can secure high permittivity and high-temperature reliability without using the rare earth elements and may be fired under the reductive atmosphere of low temperature, for example, 1260° C. or less and thus, may use the internal electrode including Ni or a Ni alloy.

Hereinafter, each component of the dielectric compositions according to the embodiment of the present invention will be described in more detail.

a) Base Powder

The base powder may use a BaTiO₃-based dielectric powder as a main component of the dielectrics. In some cases, the base powder may use (Ba₁₋ₓCaₓ)TiO₃, (Ba₁₋ₓCaₓ)(Ti_{1-y}Cay)O₃, (Ba₁₋ₓCaₓ)(Ti_{1-y}Zr_{y})O₃ or Ba (Ti_{1-y}Zr_{y})O₃ that are modified by partially bonding Ca, Zr, or the like, to BaTiO₃. In this case, an average particle size of the base powder may be preferably 0.01 to 0.5 μm or less, but is not limited thereto.

b) First Accessory Component

An example of the first accessory component may include an oxide or a carbonate including transition metals. The transition metal an oxide or a carbonate serves to impart the non-reduction and reliability of the dielectric composition.

The transition metal may be selected from a group consisting of Mn, V, Cr, Fe, Ni, Co, Cu, and Zn as a variable-valence acceptor element. The form of the transition metal an oxide or a carbonate is not particularly limited, but may use, for example, MnO₂, V₂O₅, MnCO₃, or the like.

In this case, a content of the first accessory component capable of implementing the appropriate non-reduction and reliability may be 0.1 to 1.0 at % (hereinafter, referred to as “x”) based on 100 moles of the base powder. Herein, at % represents a composition ratio of the number of atoms.

When the content of the first accessory component (x) is below 0.1 at %, the high-temperature withstand voltage characteristics are poor, the first accessory component is easily reduced at the firing of the reductive atmosphere, it may be difficult to control the grain growth, and the deterioration of resistance may easily occur.

In addition, when the content (x) of the first accessory component exceeds 1.0 at %, the high-temperature withstand voltage characteristics are poor, a sintering temperature rises, and the permittivity is degraded, such that it may be difficult to obtain the desired dielectric constant value.

c) Second Accessory Component

The second accessory component may include the oxide or the carbonate including a fixed valence acceptor element. The second accessory component serves to implement the suppression of abnormal grain growth and the non-reduction under the firing of the reductive atmosphere. As the fixed valence acceptor element, Mg or Al may be used.

In this case, a content (hereinafter, referred to as “y”) of the second accessory component in which the non-reduction may be preferably implemented may be 0.01 to 5.0 at % based on 100 moles of the base powder. When the content y of the second accessory component exceeds 5.0 at %, the firing temperature may rise and the high-temperature withstand voltage characteristics may be poor.

d) Third Accessory Component

In the related art, the non-reductive dielectric composition is added together with the rare earth element since reliability may be degraded when the fixed valence element is only doped. However, according to the embodiment of the present invention, an oxide or a carbonate including elements serving as donor as the third accessory component without including the rare earth elements may be used.

As the donor elements, for example, at least one of Ce, Nb, La, and Sb may be used. Meanwhile, the shape of donor element of an oxide or a carbonate is not particularly limited. For example, CeO₂, CeCO₃, or the like, may be used.

In this case, the content (hereinafter, referred to as “z1 to z3”) of the third accessory component capable of implementing the required non-reduction and reliability may be changed according to whether the third accessory component includes any elements.

For example, when Ce is used as the third accessory component, the at % content (z1) of the third accessory component may be 0.1≦z1≦x+2y. For example, when Nb is used as the third accessory component, the content (z2) of the third accessory component may be 0.1≦z2≦x+0.5y. When La is used as the third accessory component, the content (z3) of the third accessory component may be 0.1≦z3≦x+y.

When the contents (z1 to z3) of the third accessory component are less than 0.1 at %, the high-temperature withstand voltage characteristics may be degraded, and the non-reducible characteristics may be degraded when the contents (z1 to z3) of the third accessory component exceeds the range.

In particular, when the second accessory component and the third accessory component are co-doped within the range, the reliability may be improved, as compared with when only the first accessory component is provided.

e) Fourth Accessory Component

The fourth accessory component, which is a sintering aid lowering the firing temperature and promoting the sintering, may include the oxide or the carbonate including at least one of Si, Ba, Ca, and Al. As another example, the fourth accessory component may include a glass type including Si element.

In this case, the content of the fourth accessory component may be 0.1 to 8.0 mol % based on 100 moles of the base powder. If the content of the fourth accessory component is below 0.1 mol %, the firing temperature rises and thus, the sinterability is degraded and if the content of the fourth accessory component exceeds 8.0 mol %, the grain growth may be difficult to be controlled and the sinterability may be degraded.

Hereinafter, although Embodiments and Comparative Examples describe the present invention, these are to help understanding of the present invention. However, the scope of the present invention is not limited to the following Examples.

### Example

The slurry was prepared by mixing the base powder and the raw powder including the first to fourth accessory components with a dispersant and a binder using a zirconia ball as a mixing and dispersing media and using ethanol and toluene as a solvent according to the composition and content described in Tables 1 and 3 and then, performing ball milling for about 20 hours.

In this case, as the base powder, a BaTiO₃ powder having a mean particle size of 170 nm was used. The prepared slurry was molded into the ceramic sheet having a thickness of 3.5 μm and 10˜13 μm using a small doctor blade type of coater.

The molded ceramic sheet was printed with the Ni internal electrode. The top and bottom cover was manufactured by stacking the covering sheet of the thickness of 10 to 13 μM to 25 layers and a pressing bar was manufactured by pressing and stacking a printed active sheet of 21 layers.

The pressing bar was cut into a chip having a size of 3.2 mm×1.6 mm using a cutter. The cut chip was plasticized for debinding and was fired for about 2 hours at a temperature of about 1100 to 1250° C. under 0.1% H₂/99.9% N₂ (H₂O/H₂/N₂ atmosphere) that is the reductive atmosphere and then, heat-treated for about 3 hours at about 1000° C. under N₂ atmosphere for reoxidation.

The MLCC chip having a thickness of 3.2 mm×1.6 mm of which the dielectric thickness is 2.0 μm or less and the number of dielectric layers is 20 layers was manufactured by completing the external electrode by performing a termination process and an electrode firing process on the fired chip using Cu paste.

[Evaluation]

The normal-temperature capacitance and the dielectric loss of the MLCC chip were measured using an LCR meter under the conditions of 1 kHz, AC 0.5 V/μm. The permittivity of the MLCC chip dielectric substance was calculated from the capacitance and the dielectric thickness, the area of the internal electrode, and the number of layers of the MLCC chip.

The normal-temperature insulating resistance was measured after 60 seconds in the state in which the samples are taken by 10 and DC 10 V/μm is applied. The temperature coefficient of capacitance (TCC) was measured in the temperature range of −55° C. to 125° C.

The high-temperature IR boosting test measured the resistance deterioration behavior while increasing the voltage step by DC 10 V/μm at 150° C. and the resistance value was measured by 5 seconds, wherein the time of each step is 10 minutes.

The high-temperature withstand voltage was derived from the high-temperature IR boosting test. When the high-temperature withstand voltage was measured by applying the voltage step of DC 10 V/μm at 150° C. to the MLCC chip for 10 minutes after firing and continuously increasing the voltage step, the high-temperature withstand voltage means a voltage that withstands 10⁵Ω or more, wherein the MLCC chip has the dielectrics of 20 layers having a thickness 2 μm or less.

The RC value is a product of the normal-temperature capacitance value measured at AC 0.5V/μm and 1 kHz and the insulating resistance value measured at DC 10 V/μm. The characteristics of the proto-type chip configured of the dielectrics formed of compositions described Tables 1, 3, and 5 were shown in Tables 2, 4, and 6. In Comparative Examples, X5R applications having Y₂O₃ 0.5 moles, MgCO₃ 1.0 mole, BaCO₃ 0.4 mole, SiO₂ 1.25 moles, Al₂O₃ 0.1 moles, MnO₂ 0.05 moles, and V₂O₅ 0.05 moles based on 100 moles of the base powder were described as an example.

Table 1 shows Examples of the non-reductive dielectric composition when the third accessory component is CeO₂ and Table shows the characteristics of the proto-type chip corresponding to the compositions of these Examples.

TABLE 1

| | The number of mole of each additive material per 100 moles of the base material BaTiO₃ | | | | | | | | |
|---|---|---|---|---|---|---|---|---|---|
| | First Accessory | | Second Accessory | Third Accessory | | | Fourth Accessory | | |
| | Component | | Component | Component | | | Component | | |
| Example | MnO₂ | V₂O₅ | MgCO₃ | CeO₂ | La₂O₃ | Nb₂O₅ | BaCO₃ | Al₂O₃ | SiO₂ |
| 1 | 0.10 | 0.10 | 1.00 | 0.00 | 0.00 | 0.00 | 1.20 | 0.20 | 1.25 |
| 2 | 0.10 | 0.10 | 1.00 | 0.10 | 0.00 | 0.00 | 1.20 | 0.20 | 1.25 |
| 3 | 0.10 | 0.10 | 1.00 | 0.50 | 0.00 | 0.00 | 1.20 | 0.20 | 1.25 |
| 4 | 0.10 | 0.10 | 1.00 | 1.00 | 0.00 | 0.00 | 1.20 | 0.20 | 1.25 |
| 5 | 0.10 | 0.10 | 1.00 | 1.50 | 0.00 | 0.00 | 1.20 | 0.20 | 1.25 |
| 6 | 0.10 | 0.10 | 1.00 | 2.00 | 0.00 | 0.00 | 1.20 | 0.20 | 1.25 |
| 7 | 0.10 | 0.10 | 1.00 | 2.50 | 0.00 | 0.00 | 1.20 | 0.20 | 1.25 |
| 8 | 0.10 | 0.10 | 0.00 | 0.00 | 0.00 | 0.00 | 1.20 | 0.20 | 1.25 |
| 9 | 0.10 | 0.10 | 0.00 | 0.50 | 0.00 | 0.00 | 1.20 | 0.20 | 1.25 |
| 10 | 0.10 | 0.10 | 0.50 | 1.00 | 0.00 | 0.00 | 1.20 | 0.20 | 1.25 |
| 11 | 0.10 | 0.10 | 0.50 | 1.50 | 0.00 | 0.00 | 1.20 | 0.20 | 1.25 |
| 12 | 0.10 | 0.10 | 2.00 | 4.00 | 0.00 | 0.00 | 1.20 | 0.20 | 1.25 |
| 13 | 0.10 | 0.10 | 2.00 | 4.50 | 0.00 | 0.00 | 1.20 | 0.20 | 1.25 |
| 14 | 0.10 | 0.10 | 4.00 | 8.00 | 0.00 | 0.00 | 1.20 | 0.20 | 1.25 |
| 15 | 0.10 | 0.10 | 4.00 | 8.50 | 0.00 | 0.00 | 1.20 | 0.20 | 1.25 |
| 16 | 0.00 | 0.00 | 1.00 | 0.50 | 0.00 | 0.00 | 1.20 | 0.20 | 1.25 |
| 17 | 0.00 | 0.05 | 1.00 | 0.50 | 0.00 | 0.00 | 1.20 | 0.20 | 1.25 |
| 18 | 0.30 | 0.15 | 1.00 | 0.50 | 0.00 | 0.00 | 1.20 | 0.20 | 1.25 |
| 19 | 0.50 | 0.25 | 1.00 | 0.50 | 0.00 | 0.00 | 1.20 | 0.20 | 1.25 |

<Examples of Non-Reductive Dielectric Compositions when Third Accessory Component is CeO₂>

TABLE 2

| | Characteristics of prototype chip | | | | | | |
|---|---|---|---|---|---|---|---|
| | Appropriate | | | | | | High-temperature |
| | Singering | | | | TCC(%) | TCC(%) | Withstand |
| Example | Temperature(° C.) | Permittivity | DF(%) | RC(ΩF) | (85° C.) | (125° C.) | voltage (V/μm) |
| 1 | 1160 | 3110 | 6.24 | 7730 | −9.5% | −26.5% | 35 |
| 2 | 1160 | 4000 | 5.90 | 6520 | −8.2% | −22.4% | 50 |
| 3 | 1160 | 4500 | 7.34 | 4425 | −7.8% | −19.5% | 60 |
| 4 | 1160 | 4691 | 8.60 | 4220 | −6.5% | −19.1% | 50 |
| 5 | 1160 | 3880 | 5.01 | 2215 | −7.7% | −21.5% | 45 |
| 6 | 1160 | 2440 | 2.70 | 1540 | −8.4% | −22.0% | 35 |
| 7 | 1160 | 1853 | 2.40 | 430 | −8.7% | −24.5% | 5 |
| 8 | 1160 | 3750 | 6.25 | 3250 | −5.9% | −19.5% | 50 |
| 9 | 1160 | 4825 | 7.56 | 86 | −6.1% | −21.4% | 5 |
| 10 | 1160 | 3864 | 6.40 | 2885 | −7.8% | −25.4% | 45 |
| 11 | 1160 | 4682 | 7.88 | 165 | −7.2% | −22.2% | 5 |
| 12 | 1190 | 2358 | 3.25 | 3120 | −9.5% | −26.8% | 40 |
| 13 | 1190 | 1923 | 2.68 | 204 | −8.8% | −24.5% | 5 |
| 14 | 1220 | 2135 | 2.88 | 2240 | −11.1% | −28.5% | 35 |
| 15 | 1220 | 1684 | 2.36 | 45 | −11.2% | −29.5% | 5 |
| 16 | 1160 | 5100 | 7.52 | 12 | −12.5% | −30.2% | 5 |
| 17 | 1160 | 4732 | 7.44 | 1680 | −10.0% | −26.8% | 40 |
| 18 | 1160 | 2850 | 6.54 | 2875 | −5.5% | −20.2% | 45 |
| 19 | 1160 | 1789 | 2.44 | 1486 | −3.4% | −9.9% | 30 |
| Comparative | 1160 | 3550 | 6.88 | 3856 | −10.0% | −28.0% | 50 |
| Example | | | | | | | |
| (X5R) | | | | | | | |

<Characteristics of Proto-Type Chip Using Examples of Non-Reductive Dielectric Compositions when Third Accessory Component is CeO₂>

Referring to Examples 1 to 7, as the concentration of CeO₂ that is the third accessory component is gradually increased to 2.5 mol % under the conditions that the concentration of MgCO₃ that is the second accessory component is fixed to 1 mol %, the high-temperature withstand voltage shows a highest value, 60 V/m, in Example 3 (CeO₂: 0.5 mol %), and is reduced after exceeding the concentration and then, sharply reduced to 5 V/μm in Example 7 (CeO₂: 2.5 mol %).

The above phenomenon corresponds to the phenomenon that the normal-temperature RC value is sharply reduced to 430 ΩF in Example 7. Therefore, it could be appreciated that the non-reduction and the reliability are improved in the range in which the concentration of Ce is the specific concentration or less, but the non-reduction and the high-temperature withstand voltage characteristics are sharply degraded when the concentration of Ce exceeds the specific concentration.

In addition, it could be appreciated from Examples 7, 9, 11, 13, and 15 that as the MgCO₃ that is the second accessory component is not included (Example 9) or is gradually increased to 0.5 mol % (Example 11), 1.0 mol % (Example 7), 2.0 mol % (Example 13), and 4.0 mol % (Example 15), the concentration of CeO₂ is increased to respective 0.5 mol % (Example 9), 1.5 mol % (Example 11), 2.5 mol % (Example 7), 4.5 mol % (Example 13), and 8.5 mol % (Example 15), and the normal-temperature RC value and the high-temperature withstand voltage is sharply reduced.

In addition, it could be appreciated from Examples 16 to 19 and 3 that the normal-temperature RC value and the high-temperature withstand voltage are relatively very low when Mn and V that are the first accessory component are not included under the same conditions that Mg is 1.0 mol % and Ce is 0.5 mol %; the normal RC value 1680 and the high-temperature withstand voltage 40 V/μm characteristics are implemented when the first accessory component is 1 at % or more as in Example 17 (MnO₂: 0, V₂O₅: 0.05 at %); and the RC value 1486 and the high-temperature withstand voltage 30 V/μM characteristics are degraded when the first accessory component value is relatively excessively large as in Example 19.

Therefore, as compared with BaTiO₃, when the at % amount of the first accessory components Mn and V is set to be x, the at % amount of the second accessory component Mg is set to be y, and the at % amount of the third accessory component Ce is set to be z1; the range of x, y, and z implementing the appropriate non-reduction and reliability may be set to be 0.1≦x≦1, 0≦y≦5, and 0.1≦z≦x+2y.

Therefore, it could be appreciated that the characteristics approximately equivalent to the commercial X5R dielectric material that is Comparative Example without including the existing rare earth elements can be implemented, in the case of Examples 2 to 4 and 8 satisfying the range.

Table 3 shows Examples of the non-reductive dielectric composition when the third accessory component is La₂O₃ and Table 4 shows the characteristics of the proto-type chip corresponding to the compositions of these Examples.

TABLE 3

| | The number of mole of each additive material per 100 moles of the base BaTiO₃ | | | | | | |
|---|---|---|---|---|---|---|---|
| | First Accessory | | Second Accessory | Third Accessory | Fourth Accessory | | |
| | Component | | Component | Component | Component | | |
| Example | MnO₂ | V₂O₅ | MgCO₃ | La₂O₃ | BaCO₃ | Al₂O₃ | SiO₂ |
| 20 | 0.10 | 0.10 | 1.00 | 0.05 | 1.20 | 0.20 | 1.25 |
| 21 | 0.10 | 0.10 | 1.00 | 0.25 | 1.20 | 0.20 | 1.25 |
| 22 | 0.10 | 0.10 | 1.00 | 0.50 | 1.20 | 0.20 | 1.25 |
| 23 | 0.10 | 0.10 | 1.00 | 0.75 | 1.20 | 0.20 | 1.25 |
| 24 | 0.10 | 0.10 | 0.50 | 0.25 | 1.20 | 0.20 | 1.25 |
| 25 | 0.10 | 0.10 | 0.50 | 0.50 | 1.20 | 0.20 | 1.25 |
| 26 | 0.10 | 0.10 | 2.00 | 1.00 | 1.20 | 0.20 | 1.25 |
| 27 | 0.10 | 0.10 | 2.00 | 1.25 | 1.20 | 0.20 | 1.25 |
| 28 | 0.10 | 0.10 | 4.00 | 2.00 | 1.20 | 0.20 | 1.25 |
| 29 | 0.10 | 0.10 | 4.00 | 2.25 | 1.20 | 0.20 | 1.25 |

<Examples of Non-Reductive Dielectric Compositions when Third Accessory Component is La₂O₃>

TABLE 4

| | Characteristics of prototype chip | | | | | | |
|---|---|---|---|---|---|---|---|
| | Appropriate | | | | | | High-temperature |
| | Sintering | | | | TCC(%) | TCC(%) | Withstand |
| Example | Temperature(° C.) | Permittivity | DF(%) | RC(ΩF) | (85° C.) | (125° C.) | Voltage (V/μm) |
| 20 | 1160 | 3160 | 6.10 | 6842 | −11.1 | −27.5 | 50 |
| 21 | 1160 | 3820 | 6.75 | 7230 | −9.6 | −23.5 | 60 |
| 22 | 1160 | 4360 | 7.20 | 3452 | −8.5 | −22.3 | 55 |
| 23 | 1160 | 4472 | 7.50 | 780 | −8.3 | −23.4 | 10 |
| 24 | 1160 | 4110 | 7.55 | 3558 | −7.7 | −18.5 | 50 |
| 25 | 1160 | 3850 | 7.20 | 234 | −7.4 | −16.7 | 10 |
| 26 | 1190 | 2850 | 5.55 | 2840 | −9.5 | −26.8 | 40 |
| 27 | 1190 | 2400 | 5.23 | 180 | −8.8 | −24.5 | 5 |
| 28 | 1220 | 2066 | 3.47 | 1990 | −10.1 | −27.5 | 35 |
| 29 | 1220 | 1852 | 2.33 | 75 | −11.2 | −29.5 | 10 |
| Comparative | 1160 | 3550 | 6.88 | 3856 | −10.0 | −28.0 | 50 |
| Example | | | | | | | |

<Characteristics of Proto-Type Chip Using Examples of Non-Reductive Dielectric Compositions when Third Accessory Component is La₂O₃>

Referring to Examples 1 and 20 to 23, as the concentration of La₂O₃ that is the third accessory component is gradually increased to 0.75 mol % under the condition that the concentration of MgCO₃ that is the second accessory component is fixed to 1 mol %, the high-temperature withstand voltage shows a highest value as 60 V/m in Example 21 (La₂O₃: 0.25 mol %) and is reduced after exceeding the concentration and then, suddenly reduced to 10 V/μm in Example 23 (La₂O₃: 0.75 mol %).

The above phenomenon corresponds to the phenomenon that the normal-temperature RC value is sharply reduced to 780 ΩF that corresponds to 1000 ΩF or less in Example 23. Therefore, it could be appreciated that the non-reduction and the reliability are improved in the range in which the concentration of La₂O₃ is the specific concentration or less, but the non-reduction and the high-temperature withstand voltage characteristics are sharply degraded when the concentration of La₂O₃ exceeds the specific concentration.

In addition, it could be appreciated from Examples 25, 23, 27, and 29 that as the MgCO₃ that is the second accessory component is gradually increased to 0.5 mol % (Example 25), 1.0 mol % (Example 23), 2.0 mol % (Example 27), and 4.0 mol % (Example 29); the concentration of La₂O₃ is increased to 0.5 mol % (Example 25), 0.7 mol % (Example 23), 1.25 mol % (Example 27), and 2.25 mol % (Example 29), and the normal-temperature RC value and the high-temperature withstand voltage are sharply reduced.

Therefore, as compared with BaTiO₃, when the at % amount of the first accessory components Mn and V is set to be x, the at % amount of the second accessory component Mg is set to be y, and the at % amount of the third accessory component La is set to be z2; the range of x, y, and z2 implementing the non-reduction and reliability may be set to be 0.1≦x≦1, 0≦y≦5, 0.1≦z2≦x+y.

Therefore, it could be appreciated that the characteristics approximately equivalent to the commercial X5R dielectric material that is Comparative Example without including the existing rare earth elements can be implemented, in the case of Examples 20 to 22 and 24 satisfying the range.

Table 5 shows Examples of the non-reductive dielectric composition when the third accessory component is Nb₂O₅ and Table 6 shows the characteristics of the proto-type chip corresponding to the compositions of these Examples.

TABLE 5

| | The number of mole of each additive material per 100 moles of the base BaTiO₃ | | | | | | |
|---|---|---|---|---|---|---|---|
| | First Accessory | | Second Accessory | Third Accessory | Fourth Accessory | | |
| | Component | | Component | Component | Component | | |
| Example | MnO₂ | V₂O₅ | MgCO₃ | Nb₂O₅ | BaCO₃ | Al₂O₃ | SiO₂ |
| 30 | 0.10 | 0.10 | 1.00 | 0.05 | 1.05 | 0.20 | 1.25 |
| 31 | 0.10 | 0.10 | 1.00 | 0.25 | 1.25 | 0.20 | 1.25 |
| 32 | 0.10 | 0.10 | 1.00 | 0.50 | 1.50 | 0.20 | 1.25 |
| 33 | 0.10 | 0.10 | 0.50 | 0.10 | 0.60 | 0.20 | 1.25 |
| 34 | 0.10 | 0.10 | 0.50 | 0.35 | 0.85 | 0.20 | 1.25 |
| 35 | 0.10 | 0.10 | 2.00 | 0.50 | 2.50 | 0.20 | 1.25 |
| 36 | 0.10 | 0.10 | 2.00 | 0.75 | 2.75 | 0.20 | 1.25 |
| 37 | 0.10 | 0.10 | 4.00 | 1.00 | 5.00 | 0.20 | 1.25 |
| 38 | 0.10 | 0.10 | 4.00 | 1.25 | 5.25 | 0.20 | 1.25 |

<Examples of Non-Reductive Dielectric Compositions when Third Accessory Component is Nb₂O₅>

TABLE 6

| | Characteristics of prototype chip | | | | | | |
|---|---|---|---|---|---|---|---|
| | Appropriate | | | | | | High-temperature |
| | Sintering | | | | TCC(%) | TCC(%) | Withstand |
| Example | Temperature(° C.) | Permittivity | DF(%) | RC(ΩF) | (85° C.) | (125° C.) | Voltage(V/μm) |
| 30 | 1160 | 3198 | 7.80 | 4304 | −10.8 | −27.1 | 50 |
| 31 | 1160 | 3655 | 8.12 | 3403 | −9.2 | −22.5 | 50 |
| 32 | 1160 | 3485 | 8.24 | 40 | −8.1 | −21.3 | 5 |
| 33 | 1160 | 3680 | 6.22 | 3852 | −7.1 | −17.5 | 55 |
| 34 | 1160 | 4285 | 7.26 | 114 | −6.4 | −15.7 | 5 |
| 35 | 1190 | 2744 | 5.25 | 2235 | −9.2 | −26.2 | 40 |
| 36 | 1190 | 2456 | 4.55 | 20 | −8.1 | −23.8 | 5 |
| 37 | 1220 | 2166 | 3.22 | 1850 | −9.9 | −26.5 | 35 |
| 38 | 1220 | 1812 | 2.26 | 33 | −10.2 | −27.5 | 5 |
| Comparative | 1160 | 3550 | 6.88 | 3856 | −10.0 | −28.0 | 50 |
| Example | | | | | | | |

<Characteristics of Proto-Type Chip Using Examples of Non-Reductive Dielectric Compositions when Third Accessory Component is Nb₂O₅>

Referring to Examples 1 and 30 to 32, as the concentration of Nb₂O₅ that is the third accessory component is gradually increased from 0 mol % to 0.5 mol % under the condition that the concentration of MgCO₃ that is the second accessory component is fixed to 1 mol %, the high-temperature withstand voltage shows a highest value as 50 V/μm in Example 30 (Nb₂O₅: 0.05 mol %) and Example 31 (Nb₂O₅: 0.25 mol %) and is reduced after exceeding the concentration and then, suddenly reduced to 5 V/μm in Example 32 (Nb₂O₅: 0.5 mol %).

The above phenomenon corresponds to the phenomenon that the normal-temperature RC value is sharply reduced to 40 ΩF in Example 32. Therefore, it can be confirmed that the non-reduction and the reliability are improved in the range in which the concentration of Nb₂O₅ is the specific concentration or less, but the non-reduction and the high-temperature withstand voltage characteristics are sharply degraded when the concentration of Nb₂O₅ exceeds the specific concentration.

In addition, it could be appreciated from Examples 34, 32, 36, and 38 that as the MgCO₃ that is the second accessory component is gradually increased to 0.5 mol % (Example 34), 1.0 mol % (Example 32), 2.0 mol % (Example 36), and 4.0 mol % (Example 38); the concentration of Nb₂O₅ is each increased to 0.35 mol % (Example 34), 0.5 mol % (Example 32), 0.75 mol % (Example 36), and 1.25 mol % (Example 38), and the normal-temperature RC value and the high-temperature withstand voltage are sharply reduced.

Therefore, as compared with BaTiO₃, when the at % amount of the first accessory components Mn and V is set to be x, the at % amount of the second accessory component Mg is set to be y, and the at % amount of the third accessory component Nb is set to be z3, the appropriate range of x, y, and z implementing the non-reduction and reliability may be set to be 0.1≦x≦1, 0≦y≦5, 0.1≦z2≦x+0.5y.

Therefore, it could be appreciated that the characteristics approximately equivalent to the commercial X5R dielectric material that is Comparative Example without including the existing rare earth elements can be implemented, in the case of Examples 30, 31 and 33 satisfying the range.

As set forth above, the embodiments of the present invention can provide the dielectric composition capable of suppressing the grain growth and implementing the non-reduction approximately equivalent to the existing dielectric compositions without using the rare earth elements and being fired under the reductive atmosphere of 1160˜1220° C. while securing high-temperature reliability, and the ceramic electronic component including the same.

While the present invention has been shown and described in connection with the embodiments, it will be apparent to those skilled in the art that modifications and variations can be made without departing from the spirit and scope of the invention as defined by the appended claims.

What is claimed is:

1. A dielectric composition, comprising:
a base powder;
a first accessory component including a content (x) of 0.1 to 1.0 at % of an oxide or a carbonate including transition metals, based on 100 moles of the base powder;
a second accessory component including a content (y) of 0.01 to 5.0 at % of an oxide or a carbonate including a fixed valence acceptor element, based on 100 moles of the base powder;
a third accessory component including an oxide or a carbonate including a donor element; and
a fourth accessory component including a sintering aid.

2. The dielectric composition of claim 1, wherein the donor element of the third accessory component is Ce and
the at % content (z1) of the Ce is 0.1≦z1≦x+2y.

3. The dielectric composition of claim 1, wherein the donor element of the third accessory component is Nb, and
the at % content (z2) of the Nb is 0.1≦z2≦x+0.5y.

4. The dielectric composition of claim 1, wherein the donor element of the third accessory component is La, and
the at % content (z3) of the La is 0.1≦z3≦x+y.

5. The dielectric composition of claim 1, wherein the donor element of the third accessory component is Sb.

6. The dielectric composition of claim 1, wherein the content of the fourth accessory component is 0.1 to 8.0 mol % based on 100 moles of the base powder.

7. The dielectric composition of claim 1, wherein the sintering aid of the fourth accessory component is an oxide or a carbonate including at least one of Si, Ba, Ca, and Al.

8. The dielectric composition of claim 1, wherein the sintering aid of the fourth accessory component includes glass including Si.

9. The dielectric composition of claim 1, wherein the base powder is BaTiO₃ or at least one of (Ba₁₋ₓCaₓ)(Ti_{1-y}Ca_{y})O₃, (Ba₁₋ₓCaₓ)(Ti_{1-y}Zr_{y})O₃ and Ba (Ti_{1-y}Zr_{y})O₃.

10. The dielectric composition of claim 1, wherein the base powder is a mean particle size of 0.5 μm or less.

11. The dielectric composition of claim 1, wherein the transition metal of the first accessory component is at least one selected from a group consisting of Mn, V, Cr, Fe, Ni, Co, Cu and Zn.

12. The dielectric composition of claim 1, wherein the fixed valence acceptor element of the second accessory component is at least of Mg and Al.

13. A ceramic electronic component, comprising:
a ceramic element including a plurality of dielectric layers stacked therein;
an internal electrode formed in the ceramic element and including a non-metal; and
an external electrode formed on an outer surface of the ceramic element and electrically connected to the internal electrode,
wherein the dielectric layer includes: a base powder; a first accessory component including a content (x) of 0.1 to 1.0 at % of an oxide or a carbonate including transition metals, based on 100 moles of the base powder; a second accessory component including a content (y) of 0.01 to 5.0 at % of an oxide or a carbonate including a fixed valence acceptor element, based on 100 moles of the base powder; a third accessory component including an oxide or a carbonate including a donor element; and a fourth accessory component including a sintering aid.

14. The ceramic electronic component of claim 13, wherein the donor element of the third accessory component is Ce and
the at % content (z1) of the Ce is 0.1≦z1≦x+2y.

15. The ceramic electronic component of claim 13, wherein the donor element of the third accessory component is Nb, and
the at % content (z2) of the Nb is 0.1≦z2≦x+0.5y.

16. The ceramic electronic component of claim 13, wherein the donor element of the third accessory component is La, and
the at % content (z3) of the La is 0.1≦z3≦x+y.

17. The ceramic electronic component of claim 13, wherein the donor element of the third accessory component is Sb.

18. The ceramic electronic component of claim 13, wherein the content of the fourth accessory component is 0.1 to 8.0 mol % based on 100 moles of the base powder.

19. The ceramic electronic component of claim 13, wherein the sintering aid of the fourth accessory component is an oxide or a carbonate including at least one of Si, Ba, Ca, and Al.

20. The ceramic electronic component of claim 13, wherein the sintering aid of the fourth accessory component includes glass component including Si.

21. The ceramic electronic component of claim 13, wherein the base powder is BaTiO₃ or at least one of (Ba₁₋ₓCaₓ)(Ti_{1-y}Ca_{y})O₃, (Ba₁₋ₓCaₓ) (Ti_{1-y}Zr_{y})O₃ and Ba(Ti_{1-y}Zr_{y})O₃.

22. The ceramic electronic component of claim 13, wherein the transition metal of the first accessory component is at least one selected from a group consisting of Mn, V, Cr, Fe, Ni, Co, Cu and Zn.

23. The ceramic electronic component of claim 13, wherein the fixed valence acceptor element of the second accessory component is at least one of Mg and Al.

24. The ceramic electronic component of claim 13, wherein a thickness of each dielectric layer is 0.1 to 10 μm.

25. The ceramic electronic component of claim 13, wherein the internal electrode includes Ni or a Ni alloy.

26. The ceramic electronic component of claim 13, wherein the internal electrode is alternately stacked with the dielectric layer.
